(19) United States
(12) Patent Application Publication
(10) Pub. No.: US 2015/0367837 A1
(43) Pub. Date: Dec. 24, 2015

(54) POWERTRAIN AND METHOD FOR CONTROLLING A POWERTRAIN

(71) Applicant: GM GLOBAL TECHNOLOGY OPERATIONS LLC, Detroit, MI (US)

(72) Inventors: GORO TAMAI, WEST BLOOMFIELD, MI (US); LAN WANG, TROY, MI (US); WILLIAM L. ALDRICH, III, DAVISBURG, MI (US)

(21) Appl. No.: 14/310,583

(22) Filed: Jun. 20, 2014

(51) Int. Cl. B60W 20/00; B60W 10/06; B60W 10/08; B60W 30/188

(52) U.S. Cl. CPC B60W 20/108; B60W 20/106; B60W 30/1882; B60W 10/06; B60W 10/08; Y10S 903/93

(57) ABSTRACT

A method for controlling the powertrain includes the following steps: (a) receiving a torque request; (b) determining, via a system control module, whether the internal combustion engine is operating in an engine component-protection mode; and (c) commanding, via the system control module, the internal combustion engine and the electric motor-generator to adjust the engine output power and a motor output power, respectively, so as to generate a powertrain output power necessary to achieve the torque requested if the internal combustion engine is operating in the engine component-protection mode. Another method can control the powertrain to maintain a desired powertrain output power when an electric motor-generator is operating in a derate mode.

### TECHNICAL FIELD

The present disclosure relates to a powertrain and a method for controlling a powertrain.

### BACKGROUND

Motor vehicles include a powertrain for propulsion. For example, a powertrain includes an internal combustion engine capable of combusting an air/fuel mixture in order to generate torque. In addition to the internal combustion engine, the powertrain may include other power sources capable of propelling the vehicle. For instance, the powertrain may include at least one electric motor capable of converting electrical energy into kinetic energy. The kinetic energy generated by the electric motor can be used to propel the vehicle.

### SUMMARY

It is useful to minimize fuel consumption and maintain the powertrain output power during the operation of a vehicle powertrain, especially when the internal combustion engine operates in an engine component-protection mode or when an electric motor-generator operates in a derate mode. When operating in the engine component-protection mode, the internal combustion engine may generate an output engine power that is less than the maximum output engine power for a given torque request. Consequently, the internal combustion engine may require more fuel to achieve the torque requested when operating in the engine component-protection mode than when not operating in the engine component-protection mode. The electric motor-generator may generate an output motor power that is less than the maximum output motor power for a given torque request when operating in a derate mode. Consequently, the powertrain cannot achieve the torque requested when operating in the derate mode. A motor vehicle should nevertheless maintain its powertrain output power as well as its fuel efficiency substantially constant when either the internal combustion engine operates (or is about to operate) in an engine component-protection mode or the electric motor-generator operates (or is about to operate) in a derate mode. To this end, the present disclosure describes a method for controlling a powertrain in order to minimize fuel consumption and maintain the powertrain output power when an internal combustion engine operates (or is about to operate) in an engine component-protection mode or when an electric motor-generator operates (or is about to operate) in a derate mode.

In an embodiment, the method for controlling the powertrain includes the following steps: (a) receiving a torque request; (b) determining, via a system control module, whether the internal combustion engine is operating (or is about to operate) in an engine component-protection mode; and (c) commanding, via the system control module, the internal combustion engine and the electric motor-generator to adjust the engine output power and a motor output power, respectively, so as to generate a powertrain output power necessary to achieve the torque requested. In the present disclosure, the term “powertrain output power” refers to the power generated by the powertrain. The method described above can prevent the internal combustion engine from operating in the engine component-protection mode if the system control module determined that the internal combustion engine was about to operate in the engine component-protection mode.

In another embodiment, the method for controlling the powertrain includes the following steps: (a) receiving a torque request; (b) determining, via a system control module, whether the electric motor-generator is operating (or is about to operate) in a derate mode; and (c) commanding, via the system control module, the internal combustion engine and the electric motor-generator to adjust the engine output power and the motor output power, respectively, so as to generate a powertrain output power necessary to achieve the torque requested. The method described above can preclude the electric motor-generator from operating in the derate mode if the system control module determined that the electric motor-generator was about to operate in the derate mode.

The present disclosure also relates to a powertrain. In an embodiment, the powertrain includes an axle, an internal combustion engine operatively coupled to the axle, a first electric motor-generator operatively coupled to the axle, a second electric motor-generator operatively coupled to the axle, and a system control module in communication with the internal combustion engine, the first electric motor-generator, and the second electric motor-generator. The system control module is programmed to perform the following instructions: (a) receive a torque request; (b) determine whether the internal combustion engine is operating (or is about to operate) in an engine component-protection mode; (c) command at least one of the internal combustion engine, the first electric motor-generator, and the second electric motor-generator to adjust at least one of an engine output power and a motor output power so as to generate a powertrain output power necessary to achieve the torque requested if the internal combustion engine is operating in the engine component-protection mode.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a vehicle including a powertrain;

FIG. 2 is a flowchart of a method for controlling the powertrain of an extended range electric vehicle (EREV), wherein an internal combustion engine of the powertrain is capable of operating in an engine component-protection mode;

FIG. 3 is a flowchart of a method for determining if the disable criteria for the method of FIG. 2 have been met;

FIG. 4 is a flowchart of a method for controlling the powertrain of a hybrid electric vehicle (HEV), wherein the internal combustion engine of the powertrain is capable of operating in an engine component-protection mode;

FIG. 5 is a flowchart of a method for controlling the powertrain of an extended range electric vehicle (EREV), wherein an electric motor-generator of the powertrain is capable of operating in a derate mode;

FIG. 6 is a flowchart of a method for determining if the disable criteria for the method of FIG. 5 have been met; and

FIG. 7 is a flowchart of a method for controlling the powertrain of a hybrid electric vehicle (HEV), wherein the electric motor-generator of the powertrain is capable of operating in a derate mode.

### DETAILED DESCRIPTION

Referring to the drawings, wherein like reference numbers correspond to like or similar components throughout the several figures, FIG. 1 schematically illustrates a vehicle 10, such as a car, a motorcycle, or truck. As a non-limiting example, the vehicle 10 may be an extended range electric vehicle (EREV) or a hybrid electric vehicle (HEV) and includes a plurality of wheels 12 and a powertrain 14 capable of applying torque to the wheels 12 in order to propel the vehicle 10. In the depicted embodiment, the powertrain 14 includes a first or front axle 16 and a second or rear axle 17. Two wheels 12 are coupled to the first axle 16, and another two wheels 12 are coupled to the second axle 17. The first axle 16 is coupled to the second axle 17. Accordingly, torque can be transmitted between the first axle 16 and the second axle 17. Although the drawings show four wheels 12 and two axles (i.e., the first axle 16 and the second axle 17), it is contemplated that the powertrain 14 may include more or fewer wheels 12 and axles.

The powertrain 14 further includes an internal combustion engine 18 and a transmission 20 operatively coupled between the internal combustion engine 18 and the first axle 16. The transmission 20 may include planetary gear sets (not shown) and, regardless of its specific structure, can transmit torque between the internal combustion engine 18 and the first axle 16. For instance, the transmission 20 can selectively transmit the torque generated by the internal combustion engine 18 to the first axle 16. The internal combustion engine 18 is capable of combusting an air/fuel mixture in order to generate torque. In doing so, the internal combustion engine 18 can receive fuel, such as gasoline, from a fuel source 19. The fuel source 19 is therefore in fluid communication with the internal combustion engine 18.

In addition to the internal combustion engine 18, the powertrain 14 includes a first electric motor-generator 22A and a second electric motor-generator 22B both capable of converting electrical energy into kinetic energy in order to generate torque. Each of the first and second electric motor-generators 22A, 22B is operatively coupled to the transmission 20 and, therefore, torque can be transmitted between the transmission 20 and the first and second electric motor-generators 22A, 22B. Moreover, the first and second electric motor-generator 22A, 22B are operatively coupled to the internal combustion engine 18 (via the transmission 20) and can therefore receive kinetic energy (in the form of torque) from the internal combustion engine 18. Although the drawings show the first and second electric motor-generators 22A, 22B, it is nevertheless envisioned that the powertrain 14 may include more or fewer electric motor-generators. For example, the powertrain 14 may only include a single electric motor-generator. Because the powertrain 14 includes the internal combustion engine 18 and the first and second electric motor-generators 22A, 22B, the vehicle 10 and the powertrain 14 may be referred to as the hybrid vehicle, and the hybrid powertrain, respectively.

The powertrain 14 additionally includes at least one energy storage device 24, such as a battery or a battery pack, and each of the first and second electric motor-generators 22A, 22B is electrically connected to the energy storage device 24. The energy storage device 24 can store and supply electrical energy to the first and second electric motor-generators 22A, 22B. For example, the energy storage device 24 may be a direct current (DC) power supply capable of storing electrical energy. Irrespective of the specific kind of energy storage device 24 employed, the first and second electric motor-generators 22A, 22B can receive electrical energy from the energy storage device 24. The first and second electric motor-generator 22A, 22B may each operate in a motoring mode and a regenerating mode. In the motoring mode, the first and second electric motor-generator 22A, 22B can propel the vehicle 10 by converting the electrical energy received from the energy storage device 24 into kinetic energy. This kinetic energy is then transmitted (in the form of torque) to the wheels 12 (through the transmission 20) in order to propel the vehicle 10. In the regenerating mode, the first and second electric motor-generator 22A, 22B convert kinetic energy (originating from another power source such as the internal combustion engine 18) into electrical energy. This electrical energy is then supplied to the energy storage device 24. The powertrain 14 may further include a state of charge (SOC) sensor 25 capable of determining the SOC of the energy storage device 24.

If the vehicle 10 is an EREV, the powertrain 14 can operate in a charge-depletion mode. In the charge-depletion mode, the vehicle 10 only uses the electrical energy from the energy storage device 24. In other words, in the charge-depletion mode, the powertrain 14 may only use energy from the energy storage device 24 to propel the vehicle 10. Accordingly, the electrical energy stored in the energy storage device 24 is depleted when the vehicle 10 is operated in the charge-depletion mode. In other words, the vehicle 10 only uses the electrical energy stored in the energy storage device 24 when operating in the charge-depletion mode. In one example, in the charge-depletion mode, the powertrain 14 only uses power from the first electric motor-generator 22A and/or the second electric motor-generator 22B to propel the vehicle 10. In another example, when the powertrain 14 operates in the charge-depletion mode, most of the power used to propel the vehicle 10 originates from the first electric motor-generator 22A and/or the second electric motor-generator 22B. The powertrain 14 may also include a state of charge (SOC) hold mode to maintain the current SOC of the energy storage device 24. The SOC hold mode can be activated by the vehicle operator.

Further, if the vehicle 10 is an EREV, the powertrain 14 and vehicle 10 can also operate in a charge-sustaining mode. In the charge-sustaining mode, the vehicle 10 only uses the energy from the fuel source 19 and, therefore, the electrical energy stored in the energy storage device 24 is not depleted. As a consequence, the SOC of the energy storage device 24 is maintained while the vehicle 10 operates in the charge-sustaining mode. In one example, in the charge-sustaining mode, the powertrain 14 only uses power from the internal combustion engine 18 to propel the vehicle 10. In another example, when the powertrain 14 operates in the charge-sustaining mode, most of the power used to propel the vehicle 10 originates from the internal combustion engine 18.

The vehicle 10 includes an engine control module (ECM) 26 in communication (e.g., electronic communication) with the internal combustion engine 18. The terms “control module,” “module,” “control,” “controller,” “control unit,” “processor” and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), sequential logic circuit(s), input/output circuit(s) and devices, appropriate signal conditioning and buffer circuitry, and other components to provide the described functionality. “Software,” “firmware,” “programs,” “instructions,” “routines,” “code,” “algorithms” and similar terms mean any controller executable instruction sets. In the illustrated embodiment, the ECM 26 includes at least one memory (or any other non-transitory computer readable storage medium) and a processor configured to execute computer readable instructions or steps stored in the memory or any other computer readable storage medium. Further, the ECM 26 includes a timer capable of measuring time.

The ECM 26 controls the operation of the internal combustion engine 18 and is in communication (e.g., electronic communication) with one or more engine sensors 28 of the internal combustion engine 18. The engine sensors 28 can monitor the operation of the internal combustion engine 18 and generate input signals indicative of the operation of the internal combustion engine 18. As non-limiting examples, the engine sensors 28 include an engine oil temperature sensor, an engine cooling fluid temperature sensor, and knock sensor. The knock sensor can detect knock activity in the internal combustion engine 18, which may increase fuel consumption. The engine oil temperature sensor can measure the temperature of the engine oil, and the engine cooling fluid temperature can measure the temperature of the engine oil. It is also contemplated that the ECM 26 can command spark retard and the equivalence ratio (EQR) of the air/fuel mixture supplied to the internal combustion engine 18.

The ECM 26 can receive input signals from the engine sensors 28 and command the internal combustion engine 18 to operate in an engine-component protection mode based, at least in part, on the input signals received from the engine sensors 28. For instance, if the ECM 26 identifies knock activity based on the input signal from the knock sensor, then the ECM 26 commands the internal combustion engine 18 to operate an engine-component protection mode such as to protect the pistons of the internal combustion engine 18. In another example, if the ECM 26 determines that the temperatures of the engine oil or the engine cooling fluid are above a respective threshold value based, at least in part, on the input signals from the engine oil temperature sensor or the engine cooling oil temperature sensor, then the ECM 26 commands the internal combustion engine 18 to operate in the engine-component protection mode. When operating in the engine component-protection mode, the internal combustion engine 18 may generate an output engine power that is less than the maximum output engine power for a given torque request. Consequently, the internal combustion engine 18 may require more fuel to generate the maximum output engine power for the torque requested when operating in the engine component-protection mode than when it is not operating in the engine component-protection mode. In the present disclosure, the term “torque request” refers to a request from a vehicle operator or a vehicle control system, such as the cruise control system, to apply a specific amount of torque to the first axle 16 and/or the second axle 17. As such, the term “torque request” may also be referred to as axle torque request.

The vehicle 10 further includes a first motor controller 30A for controlling the operation of the first electric motor-generator 22A and a second motor controller 30B for controlling the operation of the second electric motor-generator 22B. The first motor controller 30A is in communication (e.g., electronic communication) with the first electric motor-generator 22A. The first electric motor-generator 22A includes first motor sensors 32A in communication with the first motor controller 30A. Thus, the first motor controller 30A can receive input signals from the first motor sensors 32A of the first electric motor-generator 22A. The second electric motor-generator 22B includes second motor sensors 32B in communication with the second motor controller 30B. The second motor controller 30B is in communication (e.g., electronic communication) with the second electric motor-generator 22B and can therefore receive input signals from the second motor sensors 32B. The first and second motor sensors 32A, 32B can monitor and measure operating parameters of the first and second electric motor-generators 22A, 22B, respectively. As a non-limiting example, the first and second motor sensors 32A, 32B include motor temperature sensors capable of monitoring and measuring the temperature of the first and second electric motor-generators 22A, 22B, respectively.

The first and second motor controllers 30A, 30B can command the first and second electric motor-generators 22A, 22B, respectively, to operate in a derate mode based on input signals from the first and second motor sensors 32A, 32B and/or thermal models. For instance, if the temperature of the first electric motor-generator 22A or the second electric motor-generator is above a predetermined temperature threshold, then the first or second motor controllers 30A, 30B commands the first or second electric motor-generators 22A, 22B to operate in the derate mode. When operating in the derate mode, the first and second electric motor-generators 22B, 22B may generate an output motor power that is less than the maximum output motor power for a given torque request. As discussed above, the torque request may originate from the vehicle operator or a vehicle control system, such as the cruise control.

The vehicle 10 further includes an actuator 34, such as an accelerator pedal, configured to receive an input from the vehicle operator. The vehicle operator can actuate the actuator 34 in order to request a particular amount of torque in the first axle 16 and/or the second axle 17.

The vehicle 10 also includes a system control module 36 in communication (e.g., electronic communication) with the actuator 34. Accordingly, the system control module 36 can receive a torque request from the actuator 34. The system control module 36 may be part of a system 38 for controlling the powertrain 14 and is in communication (e.g., electronic communication) with the ECM 26, the first motor controller 30A, the second motor controller 30B, the energy storage device 24, and the transmission 20. Consequently, the system control module 36 can receive and send signals to the ECM 26, the first motor controller 30A, the second motor controller 30B, and the energy storage device 24. The system control module 36 may also be in communication with a transmission control module (not shown) coupled to the transmission 20. In the depicted embodiment, the system control module 36 includes a processor 42 capable of executing computer-readable instructions and a memory 44 capable of storing computer-readable instructions. Although the drawings show that the memory 44 is part of the system control module 36, it is contemplated that the memory 44 may be separate from the system control module 36. The memory 44 can store instructions of the methods 100, 200, 300, 400, 500, 600, or any combination thereof. The processor 42 can execute the instructions of the methods 100, 200, 300, 400, 500, 600, or any combination thereof. Accordingly, the system control module 36 is configured and specifically programmed to perform the instructions of the methods 100, 200, 300, 400, 500, 600, or any combination thereof. The system control module 36 further includes a timer for measuring time.

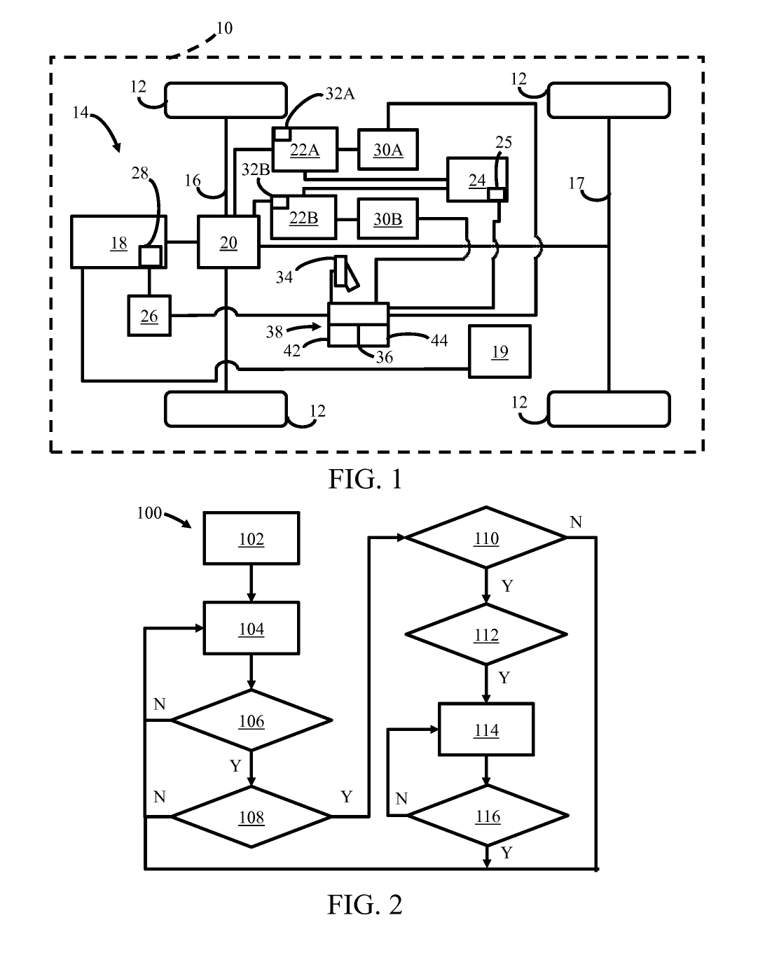

FIG. 2 is a flowchart of a method 100 for controlling the powertrain 14 in order to maximize fuel efficiency when the internal combustion engine 18 operates in the engine component-protection mode. The method 100 can alternatively be used to maximize fuel efficiency by precluding the internal combustion engine 18 from operating in the engine component-protection mode. In an embodiment, the method 100 can be used when the vehicle 10 is an EREV and begins with step 102, which entails receiving a torque request. Specifically, the system control module 36, the ECM 26, and/or the first and second motor controllers 30A, 30B receive a torque request based, for example, on an input signal from the actuator 34 or a vehicle control system, such as the cruise control. The input signal from the actuator 34 (or the vehicle control system) may be referred to as the torque request signal. This torque request signal is indicative of the torque requested by the vehicle operator through the actuator 34 or by the vehicle control system. The method 100 then proceeds to step 104.

Step 104 entails determining, via the system control module 36, an input speed and an input torque based, at least in part, on the torque requested in step 102. In the present disclosure, the term “input speed” refers to the rotational speed that should be generated by the internal combustion engine 18, the first electric motor-generator 22A, and/or the second electric motor generators 22B in order to achieve the torque requested in step 102 in the first axle 16 and/or the second axle 17. The term “input torque” refers to the torque that should be generated by the internal combustion engine 18, the first electric motor-generator 22A, and/or the second electric motor generators 22B in order to achieve the torque requested in step 102 in the first axle 16 and/or the second axle 17. Next, the method 100 continues to step 106.

Step 106 entails determining, via the system control module 36, whether the internal combustion engine 18 is operating (or is about to operate) in the engine-component protection mode. As discussed above, the ECM 26 can command the internal combustion engine 18 to operate in the engine-component protection mode based on the input from the engine sensors 28. Accordingly, the ECM 26 can generate and send an input signal to the system control module 36 indicating that the internal combustion engine 18 is operating (or is about to operate) in the engine-component protection mode. The input signal indicative that the internal combustion engine 18 is operating in the engine-component protection mode may be referred to as the component protection signal. Therefore, upon receipt of the input signal from the ECM 26 (i.e., the component protection signal), the system control module 36 determines that the internal combustion engine 18 is operating (or is about to operate) in the engine component-protection mode. As a non-limiting example, the system control module 36 can determine that the internal combustion engine 18 is about to operate in the engine component-protection mode in the near future or is currently operating in the engine component-protection mode when an engine operating parameter measured by the engine sensor 28, such as the engine oil temperature, is above a predetermined threshold value. Alternatively, the system control module 36 can determine that the internal combustion engine 18 is about to operate in the engine component-protection mode or is currently operating in the engine component-protection mode when an engine operating parameter, such as the equivalence ratio (EQR) of the air/fuel mixture, is outside or within a predetermined range.

If the system control module 36 determines that the internal combustion engine 18 is not operating in the engine component-protection mode or is not about to operate in the engine component-protection mode, then the method 100 returns to step 104. The system control module 36 can determine that the internal combustion engine 18 is not operating in the engine-component protection mode if, for example, it does not receive the component protection signal from the ECM 26. If the system control module 36 determines that the internal combustion engine 18 is operating (or is about to operate) in the engine-component protection mode, then the method 100 proceeds to step 108.

Step 108 entails determining, via the system control module 36, whether the powertrain 14 is operating in a steady state drive condition. In the present disclosure, the term “steady state drive condition” is a powertrain operating condition in which the change rate of the axle torque is less than a predetermined rate threshold. The term “axle torque” refers to the torque in the first axle 16 and/or the second axle 17. In step 108, the system control module 36 determines whether the change rate of the axle torque is less than a predetermined rate threshold in order to determine whether the powertrain 14 is operating in a steady state drive condition. If the powertrain 14 is not operating in a steady state drive condition, then the method 100 returns to step 104. Conversely, if the powertrain 14 is operating in a steady state drive condition, then the method 100 proceeds to step 110.

Step 110 entails determining, via the system control module 36, whether the powertrain 14 (and consequently the vehicle 10) is operating in the charge-sustaining mode or in the charge-depletion mode in conjunction with the SOC hold mode if the powertrain 14 is operating in a steady state drive condition. If the powertrain 14 is not operating in the charge-sustaining mode or in the charge-depletion mode in conjunction with the SOC hold mode, then the method 100 returns to step 104. Conversely, if the control module 22 determines that the powertrain 14 is operating in either the charge-sustaining mode or in the charge-depletion mode in conjunction with the SOC hold mode, then the method 100 proceeds to step 112.

Step 112 entails determining, via the system control module 36, whether the current SOC of the energy storage device 24 is greater than a predetermined SOC threshold. The predetermined SOC threshold is different depending on the operating mode of the powertrain 14. In particular, if the powertrain 14 is operating in the charge-sustaining mode, the system control module 36 determines if the current SOC of energy storage device 24 is greater than a first predetermined SOC threshold. If the powertrain 14 is operating in the charge-depletion mode in conjunction with the SOC hold mode, the system control module 36 determines if the current SOC of the energy storage device 24 is greater than a second SOC threshold. The first and second predetermined SOC thresholds are not the same and can be calibration values determined by testing the powertrain 14. The system control module 36 can determine the current SOC of the energy storage device 24 based, at least in part, on an input signal from the SOC sensor 25 and then compares the current SOC of the energy storage device 24 with the appropriate predetermined SOC threshold (i.e., the first or second predetermined SOC threshold values) in accordance with the operating mode of the powertrain 14. If the current SOC of the energy storage device 24 is not greater than the appropriate predetermined SOC threshold (i.e., the first or second predetermined SOC threshold values), then the method 100 returns to step 104. On the other hand, if the current SOC of the energy storage device 24 is greater than the appropriate predetermined SOC threshold (i.e., the first or second predetermined SOC threshold values), then the method 100 proceeds to step 114.

Step 114 entails commanding, via the system control module 36, the internal combustion engine 18 and the first and/or second electric motor-generators 22A, 22B to adjust their engine output power and motor output power, respectively, so as to generate the powertrain output power necessary to achieve the torque requested in step 102 if the internal combustion engine 18 is operating in the engine component-protection mode. Thus, step 114 also entails adjusting the engine output power of the internal combustion engine 18 and the motor output power of the first and/or second electric motor-generators 22A, 22B as to generate the powertrain output power necessary to achieve the torque requested in step 102 if the internal combustion engine 18 is operating in the engine component-protection mode. In step 114, the system control module 36 commands the internal combustion engine 18 to decrease its engine output power and the first electric motor-generator 22A and/or the second electric motor-generator 22B to increase their motor output power. The increase in motor output power is a function of the decrease in engine output power. For example, the increase in motor output power may be proportional to the decrease in engine output power. In step 114, the system control module 36 can send the command to the internal combustion engine 18 to decrease its engine output power through the ECM 26. Further, the system control module 36 can send the command to the first electric motor-generator 22A and/or the second electric motor-generator 22B to increase their motor output power through the first and second motor controllers 30A, 30B. Thus, step 114 also entails decreasing the engine output power generated by the internal combustion engine 18 and increasing the motor output power generated by the first electric motor-generator 22A and/or the second electric motor-generator 22B so as to generate the powertrain output power necessary to achieve the torque requested in step 102 if the internal combustion engine 18 is operating in the engine component-protection mode.

Step 114 alternatively entails commanding, via the system control module 36, the internal combustion engine 18 and the first and/or second electric motor-generators 22A, 22B to adjust their engine output power and motor output power, respectively, so as to preclude the internal combustion engine 18 from operating in the engine component-protection mode. To do so, the system control module 36 commands the internal combustion engine 18 to decrease its engine output power and the first electric motor-generator 22A and/or the second electric motor-generator 22B to increase their motor output power as described above. Step 114 additionally includes adjusting the engine output power of the internal combustion engine 18 and the motor output power of the first and/or second electric motor-generators 22A, 22B so as to preclude the internal combustion engine from operating in the engine component-protection mode. The method 100 then continues to step 116.

Step 116 entails determining, via the system control module 36, if disable criteria is met. The system control module 36 can determine whether the disable criteria have been met according to the method 200 described above or any other suitable method. If the disable criteria have not been met, then the method 100 returns to step 114. On the other hand, if the disable criteria have been met, then the method 100 returns to step 104.

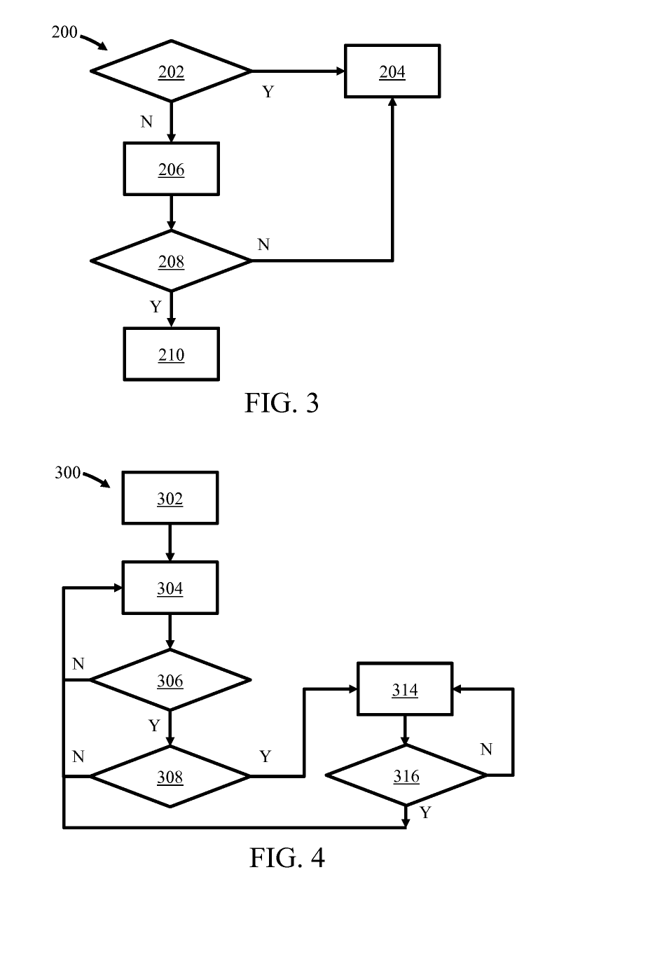

FIG. 3 is a flowchart of a method for determining if the disable criteria for the method 100 have been met. The method 200 begins with step 202, which entails determining whether the internal combustion engine 18 is operating in the engine-component protection mode. In step 202, the system control module 36 can determine whether the internal combustion engine 18 is operating in the engine-component protection mode based, at least in part, on data received from the ECM 26 as discussed above. If the internal combustion engine 18 is operating in the engine-component protection mode, then the method 200 continues to step 204, in which the system control module 36 determines that the disable criteria have not been met. However, if the internal combustion engine 18 is not operating in the engine-component protection mode, then the method 200 continues to step 206.

Step 206 entails starting a timer in order to measure time. As discussed above, the timer may be part of the system control module 36. Thus, in step 206, the system control module 36 starts measuring time. Next, the method 200 proceeds to step 208.

Step 208 entails determining, via the system control module 36, whether a predetermined amount of time passed since the timer was started in step 206. To do so, the system control module 36 can compare the time in the timer with a predetermined time threshold. If the time measured by the timer does not exceed the predetermined amount of time since the timer was started in step 206, then the method 200 continues to step 204, in which the system control module 36 determines that the disable criteria have not been met. Conversely, if the time measured by the timer exceeds the predetermined amount of time since the timer was started in step 206, then the method 200 continues to step 210, in which the system control module 36 determines that the disable criteria have been met. In step 210, the system control module 36 determines that the disable criteria have been met.

FIG. 4 is a flowchart of method 300 for controlling the powertrain 14 in order to maximize fuel efficiency when the internal combustion engine 18 operates (or is about to operate) in the engine-component protection mode and the vehicle 10 is a HEV. The method 300 is substantially similar to the method 100, except for the steps described in detail below. Thus, in the interest of brevity, only the differences between methods 100 and 300 are described below in detail. The method 300 begins with step 302, which is identical to the step 102 described above. Then, the method 300 continues to step 304, which is identical to the step 104. Next, the method 300 proceeds to step 306, which is identical to the step 106 of the method 100. Then, the method 300 continues to step 308, which is identical to the step 108 of the method 100. The method 300 does not necessarily include a step corresponding to the step 110 or a step corresponding to step 112 of the method 100. Thus, after step 308, the method 300 proceeds to step 314.

Step 314 of the method 300 entails commanding, via the system control module 36, the internal combustion engine 18 to increase its engine speed to generate the powertrain output power necessary to achieve the torque requested in step 302 if the internal combustion engine 18 is operating in the engine component-protection mode. The increase of the engine speed can be a function of the parameters used to activate the engine-component protection mode in order to achieve an engine output power in accordance with the torque requested. For example, the increase in engine speed may be a function of the engine oil temperature or the engine cooling fluid temperature. Therefore, step 314 also entails increasing the engine speed of the internal combustion engine 18 to generate the powertrain output power necessary to achieve the torque requested in step 302 if the internal combustion engine 18 is operating in the engine component-protection mode. Next, the method 300 proceeds to step 316. Step 316 is identical to step 116 of method 100.

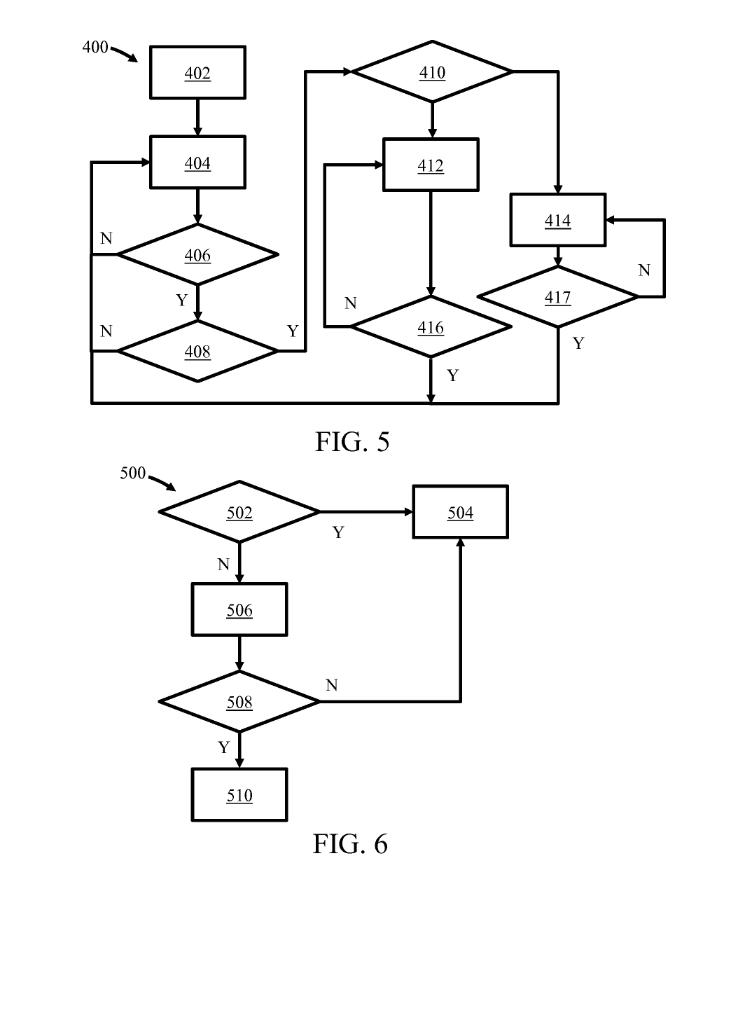

FIG. 5 is a flowchart of a method 400 for controlling the powertrain 14 in order to maintain powertrain output power when the first and/or second electric motor-generators 22A, 22B operate in the derate mode and the vehicle 10 is an EREV. The method 400 can alternatively be used to maintain powertrain output power by precluding the first and/or second electric motor-generators 22A, 22B from operating in the derate mode. In an embodiment, the method 400 begins with step 402, which entails receiving a torque request. Specifically, the system control module 36, the ECM 26, and/or the first and second motor controllers 30A, 30B receive a torque request from the actuator 34 or a vehicle control system, such as the cruise control. This torque request signal is indicative of the torque requested by the vehicle operator through the actuator 34 or by the vehicle control system. The method 100 then proceeds to step 104.

Step 404 entails determining, via the system control module 36, an input speed and an input torque based, at least in part, on the torque requested in step 402. In the present disclosure, the term “input speed” refers to the rotational speed that should be generated by the internal combustion engine 18, the first electric motor-generator 22A, and/or the second electric motor generators 22B in order to achieve the torque requested in step 402 in the first axle 16 and/or the second axle 17. The term “input torque” refers to the torque that should be generated by the internal combustion engine 18, the first electric motor-generator 22A, and/or the second electric motor generators 22B in order to achieve the torque requested in step 402 in the first axle 16 and/or second axle 17. Next, the method 400 continues to step 406.

Step 406 entails determining, via the system control module 36, whether the first electric motor-generator 22A and/or the second electric motor-generator 22B are operating (or are about to operate) in the derate mode. As discussed above, the first and second motor controllers 30A, 30B can command the first electric motor-generator 22A and the second electric motor-generator 22B to operate in the derate mode based on the input from the first and second motor sensors 32A, 32B. For example, the first motor sensor 32A and/or the second motor sensor 32B can be temperature sensors, and the first and second motor controllers 30A, 30B can command the first and/or second electric motor-generators 22A, 22B to operate in the derate mode when the temperature in either the first or second electric motor-generators 22A, 22B (i.e., the first and second motor temperatures) is greater than a predetermined temperature threshold value. The first and second motor controllers 30A, 30B can generate and send an input signal to the system control module 36 indicating that either the first electric motor-generator 22A or the second electric motor-generator 22B is operating (or is about to operate) in the derate mode. The input signal indicative that the first electric motor-generator 22A and/or the second electric motor-generator 22B are operating (or are about to operate) in the derate mode may be referred to as the motor derate signal. Therefore, upon receipt of the input signal from the first and/or second motor controllers 30A, 30B (i.e., the motor derate signal), the system control module 36 determines that the first electric motor-generator 22A and/or the second electric motor-generator 22B are operating (or are about to operate) in the derate mode. As a non-limiting example, the system control module 36 can determine that either the first electric motor-generator 22A or the second motor-generator 22B is about to operate in the derate mode in the near future or is currently operating in the derate mode when a motor operating parameter measured by the first and second motor sensors 32A, 32B, such as the motor temperature, is above a predetermined temperature threshold. Alternatively, the system control module 36 can determine that either the first electric motor-generator 22A or the second electric motor-generator 22B is about to operate in the derate mode or is currently operating in the derate mode when a motor operating parameter, such as the motor temperature, is outside or within a predetermined range.

If the system control module 36 determines that the first electric motor-generator 22A and the second electric motor-generator 22B are not operating (or are not about to operate) in the derate mode, then the method 400 returns to step 404. The system control module 36 can determine that the first electric motor-generator 22A and the second electric motor-generator 22B are not operating in the derate mode if, for example, the system control module 36 does not receive the motor derate signal from the first and second motor controllers 30A, 30B. If the system control module 36 determines that either the first electric motor-generator 22A or the second electric motor-generator 22B is operating (or is about to operate) in the derate mode, then the method 400 proceeds to step 408.

Step 408 entails determining, via the system control module 36, whether the powertrain 14 is operating in a steady state drive condition. As discussed above, the term “steady state drive condition” is a powertrain operating condition in which the change rate of the axle torque is less than a predetermined rate threshold. The term “axle torque” refers to the torque in the first axle 16 and/or the second axle 17. In step 408, the system control module 36 determines whether the change rate of the axle torque is less than a predetermined rate threshold in order to determine whether the powertrain 14 is operating in a steady state drive condition. If the powertrain 14 is not operating in a steady state drive condition, then the method 400 returns to step 404. Conversely, if the powertrain 14 is operating in a steady state drive condition, then the method 400 proceeds to step 410.

Step 410 entails determining, via the system control module 36, whether the powertrain 14 (and consequently the vehicle 10) is operating in the charge-sustaining mode or in the charge-depletion mode. If the powertrain 14 is operating in the charge-sustaining mode, then the method 400 continues to step 412. If the powertrain 14 is operating the charge-depletion mode, then the method 400 continues to step 414.

Step 412 entails commanding, via the system control module 36, the internal combustion engine 18 and the first and/or second electric motor-generators 22A, 22B to adjust their engine output power and motor output power, respectively so as to generate the powertrain output power necessary to achieve the torque requested in step 402. In step 412, the system control module 36 commands the internal combustion engine 18 to increase its engine output power and the first electric motor-generator 22A and/or the second electric motor-generator 22B to decrease their motor output power. The decrease in motor output power is a function of the increase in engine output power. For instance, the decrease in motor output power may be proportional to the increase in engine output power. In step 412, the system control module 36 can send the command to the internal combustion engine 18 to increase its engine output power through the ECM 26. Further, the system control module 36 can send the command to the first electric motor-generator 22A and/or the second electric motor-generator 22B to decrease their motor output power through the first and second motor controllers 30A, 30B. Therefore, step 412 also entails adjusting the engine output power of the internal combustion engine 18 and the motor output power of the first electric motor-generator 22A and/or the second electric motor-generator 22B as described above in order to generate the powertrain output power necessary to achieve the torque requested in step 402.

Step 412 alternatively entails commanding, via the system control module 36, the internal combustion engine 18 and the first and/or second electric motor-generators 22A, 22B to adjust their engine output power and motor output power, respectively, so as to preclude the first and/or second electric motor-generators 22A, 22B from operating in the derate mode. To do so, the system control module 36 commands the internal combustion engine 18 to increase its engine output power and the first electric motor-generator 22A and/or the second electric motor-generator 22B to decrease their motor output power as described above. Thus, step 412 further includes adjusting the engine output power of the internal combustion engine 18 and the motor output power of the first and/or second electric motor-generators 22A, 22B as described above in order to preclude the first and/or second electric motor-generators 22A, 22B from operating in the derate mode. The method 400 then continues to step 416.

Step 416 entails determining, via the system control module 36, if disable criteria is met. The system control module 36 can determine whether the disable criteria have been met according to the method 500 described above or any other suitable method. If the disable criteria have not been met, then the method 400 returns to step 412. On the other hand, if the disable criteria have been met, then the method 400 returns to step 404.

Step 414 entails commanding the electric motor-generator (i.e., first electric motor-generator 22A and/or the second electric motor-generator 22B) that is operating (or is about to operate) in the derate mode to reduce its motor output torque. The motor output torque of the electric motor-generator (i.e., first electric motor-generator 22A and/or the second electric motor-generator 22B)) operating in the derate mode is reduced so as to minimize power losses from this motor. Accordingly, the system control module 36 can determine the motor output torques for the first and second electric motor-generators 22A, 22B that will produce the torque requested while minimizing power. Then, the system control module 36 can command the electric motor-generator (i.e., first electric motor-generator 22A and/or the second electric motor-generator 22B) that is operating (or is about to operate) in the derate mode to reduce its motor output torque through the first and second motor controllers 30A, 30B.

Step 417 entails determining, via the system control module 36, if disable criteria is met. The system control module 36 can determine whether the disable criteria have been met according to the method 500 described above or any other suitable method. If the disable criteria have not been met, then the method 400 returns to step 414. On the other hand, if the disable criteria have been met, then the method 400 returns to step 404.

FIG. 6 is a flowchart of a method for determining if the disable criteria for the method 400 have been met. The method 500 begins with step 502, which entails determining whether either the first electric motor-generator 22A or the second electric motor-generator 22B is operating in the derate mode. In step 502, the system control module 36 can determine whether either first electric motor-generator 22A or the second electric motor-generator 22B is operating in the derate mode based, at least in part, from data received from the first and second motor controllers 30A, 30B. If either the first electric motor-generator 22A or the second electric motor-generator 22B is operating in the derate mode, then the method 500 continues to step 504, in which the system control module 36 determines that the disable criteria have not been met. However, if neither first electric motor-generator 22A nor the second electric motor-generator 22B is operating in the derate mode, then the method 500 continues to step 506.

Step 506 entails determining starting a timer in order to measure time. As discussed above, the timer may be part of the system control module 36. Thus, in step 506, the system control module 36 starts measuring time. Next, the method 500 proceeds to step 508.

Step 508 entails determining, via the system control module 36, whether a predetermined amount of time passed since the timer was started in step 506. To do so, the system control module 36 can compare the time in the timer with a predetermined time threshold. If the time measured by the timer does not exceed the predetermined amount of time since the timer was started in step 506, then the method 500 continues to step 504 in which the system control module 36 determines that the disable criteria have not been met as discussed above. Conversely, if the time measured by the timer exceeds the predetermined amount of time since the timer was started in step 506, then the method 500 continues to step 510. In step 510, the system control module 36 determines that the disable criteria have been met.

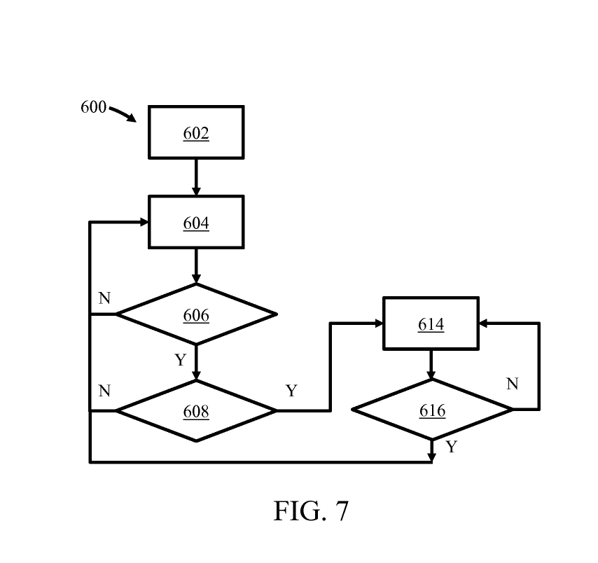

FIG. 7 is a flowchart of method 600 for controlling the powertrain 14 in order to maintain powertrain output power when the powertrain 14 operates (or is about to operate) in the derate mode and the vehicle 10 is a HEV. The method 600 is substantially similar to the method 400, except for the steps described in detail below. Thus, in the interest of brevity, only the differences between methods 400 and 600 are described below in detail. The method 600 begins with step 602, which is identical to the step 402 described above. Then, the method 600 continues to step 604, which is identical to the step 404. Next, the method 600 proceeds to step 606, which is identical to the step 406 of the method 400. Then, the method 600 continues to step 608, which is identical to the step 408 of the method 400. The method 600 does not necessarily include a step corresponding to the step 410 of the method 400. Thus, after step 608, the method 600 proceeds to step 614.

Step 614 entails commanding the internal combustion engine 18 to increase its engine output power and the first electric motor-generator 22A and/or the second electric motor-generator 22B to decrease their motor output power. The decrease in motor output power is a function of the increase in engine output power. In step 614, the system control module 36 can send the command to the internal combustion engine 18 to increase its engine output power through the ECM 26. Further, the system control module 36 can send the command to the first electric motor-generator 22A and/or the second electric motor-generator 22B to decrease their motor output power through the first and second motor controllers 30A, 30B. Step 614 also includes adjusting the engine output power of the internal combustion engine 18 and the motor output power of the first electric motor-generator 22A and/or the second electric motor-generator 22B as described above. The method 600 then continues to step 616.

Step 616 entails determining, via the system control module 36, if disable criteria is met. The system control module 36 can determine whether the disable criteria have been met according to the method 500 described above or any other suitable method. If the disable criteria have not been met, then the method 600 returns to step 614. On the other hand, if the disable criteria have been met, then the method 600 returns to step 604.

While the best modes for carrying out the invention have been described in detail, those familiar with the art to which this invention relates will recognize various alternative designs and embodiments for practicing the invention within the scope of the appended claims. The methods 100, 200, 300, 400, 500, 600 can be combined with one another in any suitable combination, and the steps of these methods do not need to be performed in the specific chronological order described in the present disclosure. Accordingly, the system control module 36 and the system 38 can be configured and programmed to execute the steps of the methods 100, 200, 300, 400, 500, 600 (or any combination thereof) in any suitable chronological order.

1. A method for controlling a powertrain, the powertrain including an internal combustion engine and an electric motor-generator, the method comprising:
receiving a torque request;
determining, via a system control module, whether the internal combustion engine is operating in an engine component-protection mode; and
commanding, via the system control module, the internal combustion engine and the electric motor-generator to adjust an engine output power and a motor output power, respectively, so as to generate a powertrain output power necessary to achieve the torque requested if the internal combustion engine is operating in the engine component-protection mode.

2. The method of claim 1, further comprising determining whether the powertrain is operating in a steady state drive condition, wherein the powertrain is operating in the steady state drive condition if a change rate on an axle torque is less than a predetermined rate threshold.

3. The method of claim 2, further comprising determining whether the powertrain is operating in a charge-sustaining mode or in charge depletion mode in conjunction with a state of charge (SOC) hold mode being activated if the powertrain is operating in the steady state drive condition.

4. The method of claim 3, further comprising determining whether a current state of charge (SOC) of an energy storage device electrically connected to the electric motor-generator is greater than a predetermined SOC threshold if the powertrain is operating in the charge-sustaining mode.

5. The method of claim 4, wherein commanding the internal combustion engine to adjust the engine output power includes decreasing the engine output power.

6. The method of claim 5, wherein commanding the electric motor-generator to adjust the motor output power includes increasing the motor output power.

7. The method of claim 6, wherein the increase in motor output power is a function of the decrease in engine output power.

8. The method of claim 1, wherein commanding the internal combustion engine to adjust the engine output power includes increasing an engine speed in order to generate the powertrain output power necessary to achieve the torque requested if the internal combustion engine is operating in the engine component-protection mode.

9. The method of claim 1, wherein an increase in engine speed is a function of parameters used to activate the engine component-protection mode.

10. A method for controlling a powertrain, the powertrain including an internal combustion engine and an electric motor-generator, the method comprising:
receiving a torque request;
determining, via a system control module, whether the electric motor-generator is operating in a derate mode; and
commanding, via the system control module, the internal combustion engine and the electric motor-generator to adjust an engine output power and a motor output power, respectively, so as to generate a powertrain output power necessary to achieve the torque requested if the electric motor-generator is operating in the derate mode.

11. The method of claim 10, further comprising determining whether the powertrain is operating in a steady state drive condition, wherein the powertrain is operating in the steady state drive condition if a change rate on an axle torque is less than a predetermined rate threshold.

12. The method of claim 10, further comprising determining whether the powertrain is operating in a charge-sustaining mode if the powertrain is operating in a steady state drive condition.

13. The method of claim 12, wherein commanding the internal combustion engine and the electric motor-generator to adjust the engine output power and the motor output power, respectively, includes increasing the engine output power and decreasing the motor output power if the powertrain is operating in the charge-sustaining mode.

14. The method of claim 10, further comprising determining whether the powertrain is operating in a charge-depletion mode.

15. The method of claim 14, wherein the electric motor-generator is a first electric motor-generator, the powertrain includes a second electric motor-generator, and the method further includes commanding the first electric motor-generator operating in the derate mode to decrease torque in order to decrease a power loss of the first electric motor-generator, and commanding the second electric motor-generator that is not operating in the derate mode to increase torque to maintain the powertrain output power.

16. The method of claim 10, wherein the powertrain is part of a hybrid electric vehicle and commanding the internal combustion engine and the electric motor-generator to adjust the engine output power and the motor output power, respectively, includes increasing the engine output power and decreasing a motor output power.

17. A powertrain, comprising:
an axle;
an internal combustion engine operatively coupled to the axle;
a first electric motor-generator operatively coupled to the axle;
a second electric motor-generator operatively coupled to the axle;
and
a system control module in communication with the internal combustion engine, the first electric motor-generator, and the second electric motor-generator, wherein the system control module is programmed to:
receive a torque request;
determine whether the internal combustion engine is about to operate in an engine component-protection mode based, at least in part, on an engine operating parameter; and
command at least one of the internal combustion engine, the first electric motor-generator, and the second electric motor-generator to adjust at least one of an engine output power and a motor output power so as to generate a powertrain output power necessary to achieve the torque requested and preclude the internal combustion engine from operating in the engine component-protection mode.

18. The powertrain of claim 17, wherein the system control module is programmed to determine whether at least one of the first and second electric motor-generators is about to operate in a derate mode.

19. The powertrain of claim 18, wherein the system control module is also programmed to command at least one of the internal combustion engine, the first electric motor-generator, and the second electric motor-generator to adjust at least one of the engine output power and the motor output power if at least one of the first and second electric motor-generators is about to operate in the derate mode so as to preclude the other of the first and second electric motor-generators from operating in the derate mode.

20. The powertrain of claim 18, wherein the system control module is configured to determine that the internal combustion engine is about to operate in the engine component-protection mode when the engine operating parameter is above a predetermined threshold value.
